(19) United States
(12) Patent Application Publication
(10) Pub. No.: US 2026/0090535 A1
(43) Pub. Date: Apr. 2, 2026

(54) NUISANCE ANIMAL TRAP

(71) Applicants: Jack J. Kennamer, Maineville, OH (US); Pierce M. Kennamer, Boca Raton, FL (US)

(72) Inventors: Jack J. Kennamer, Maineville, OH (US); Pierce M. Kennamer, Boca Raton, FL (US)

(21) Appl. No.: 19/404,202

(22) Filed: Dec. 1, 2025

Related U.S. Application Data
(63) Continuation-in-part of application No. 19/068,073, filed on Mar. 3, 2025.
(60) Provisional application No. 63/560,948, filed on Mar. 4, 2024.
(60) Provisional application No. 63/727,235, filed on Dec. 3, 2024.

(51) Int. Cl. A01M 23/10

(52) U.S. Cl. CPC A01M 23/10

(57) ABSTRACT

A trap with an access door assembly is designed to catch multiple nuisance animals in one setting. The trap in various embodiments includes a large box or retention cage with an opening on at least one side with a removable access door assembly coupled to the retention cage and in communication with the opening. A one-way entry door is provided in the door assembly designed such that once the animal has started through the door it cannot turn back. The animal continues through the one-way door and enters the retention cage via the opening. Once the retention cage is full or at another convenient time, the retention cage is removed from the access door assembly and replaced with another retention cage.

This claims priority to U.S. Provisional Patent Application Ser. No. 63/727,235, filed Dec. 3, 2024 and is a continuation in part of U.S. patent application Ser. No. 19/068,073, filed Mar. 3, 2025 which claimed priority to U.S. Provisional Patent Application Ser. No. 63/560,948, filed Mar. 4, 2024 and is related to U.S. Provisional Patent Application Ser. No. 63/332,717, filed Apr. 20, 2022, and U.S. Utility patent application Ser. No. 18/131,152, filed Apr. 5, 2023 which matured into U.S. Pat. No. 12,245,581 issued on Mar. 11, 2025. Each of these prior applications/patents is hereby incorporated by reference in its entirety.

### BACKGROUND OF THE INVENTION

This invention relates generally to animal traps, and more specifically, to an animal trap with a door assembly designed to capture nuisance species.

One common nuisance species is an iguana which is an herbivorous lizard with exceptional vision native to tropical areas of Mexico, Central America, and the Caribbean. These pests are non-native to North America and the infestation of iguanas in the United States has caused havoc for residents and native species. South and Central Florida's subtropical climate allows these large herbivorous lizards to survive, reproduce, and become part of the Florida environment.

Iguanas are an invasive species in the southern US. They have no natural predators once they become an adult, so they are multiplying in record numbers. They are causing millions and millions of dollars in property damage annually. The iguanas have now moved in to farming communities and are devastating domestic produce production costing farmers enormous loses.

Iguanas cause damage to residential and commercial landscape vegetation and are often considered a nuisance by property owners. Iguanas are attracted to trees with foliage or flowers, most fruits and almost any vegetable. Some green iguanas cause damage to infrastructure by digging burrows that erode and collapse sidewalks, foundations, seawalls, berms and canal banks. Green iguanas may also leave droppings on docks, moored boats, seawalls, porches, decks, pool platforms and inside swimming pools. Although primarily herbivores, researchers found the remains of tree snails in the stomachs of green iguanas in Florida State Parks, suggesting that iguanas could present a threat to native and endangered species of tree snails. As is the case with other reptiles, green iguanas can also transmit the infectious bacterium salmonella to humans through contact with water or surfaces contaminated by their feces.

Additionally, they defecate in common public areas such as pools, parks, playgrounds, and docks, causing health risks as their feces carry salmonella. Moreover, the burrows they dig undermine sidewalks, seawalls, and foundations causing structural damage. As vegetarians, the four-footed reptiles eat their way through landscaping. They sunbathe during the day and cozy up in treetops by night. They can lay as many as seventy five (75) eggs in a single burrow each year. Although iguanas are docile, there are many reported incidents where they have harmed pets and individuals. As with any species, they are territorial, the more dominant males will push the less dominant males to surrounding areas, which leads to infestation.

Most known nuisance animal traps have a limited capacity requiring a handler to empty the trap on a frequent basis. Moreover, the trapping and retention mechanisms for most known traps are often ineffective and limited to a particular species or type of animal.

Hence, there is a long pending need to have a system and method of controlling a wide variety of nuisance species which is effective and does not need to be entirely removed or re-located when full.

### SUMMARY OF THE INVENTION

A system and method for trapping and containing a variety of nuisance species are provided by various embodiments of this invention. A trap that can collect multiple species, including but not limited to iguanas, will enhance the ability to control nuisance animals effectively and economically.

This invention is a trap and an access door assembly according to various embodiments and is designed to catch multiple nuisance animals in one setting. The features of the trap in various embodiments include a large box or retention cage with an opening on at least one side with a removable access door assembly coupled to the retention cage and in communication with the opening. A one-way entry gate is provided in the door assembly designed such that once the animal has started through the gate it cannot turn back. The animal continues through the one-way door and enters the retention cage via the opening. Once the retention cage is full or at another convenient time, the retention cage is removed from the access door assembly and replaced with another retention cage. A bait station that can hold several days of bait/food and be easily rebaited with minimal contact with the trap is also provided.

The trap in various embodiments may be designed to be easily disassembled for easy transportation and shipping. The trap may have one or more anchor points so it can be securely anchored to prevent the trap from being stolen or blowen away in bad weather such as a hurricane. The access door may allow for only entry into the cage or be locked all together to prevent unauthorized access to the trap and its contents. The trap is designed to operate quietly with no slamming doors or other components that would cause noises that would scare away the animals to be trapped.

The trap may include an additional removable auxiliary retention cages. The animal will pass through the one-way door that will not let it back out of the trap. The door to the retention cage is designed such that once the animal has started through the door, it cannot turn back. It can only move forward through the opening into the retention cage. The retention cage may be removable and replaceable with another retention cage. This would allow the trapper to quickly remove all of the trapped animals in the cage and reinstall an empty cage without disturbing the door assembly of the trap.

The door assembly and or the retention cage may have retainers to releasably secure the door assembly to the retention cage and make sure the transfer opening is properly aligned between the two structures, and that the animals can't escape. The retention cage may have a way to secure the opening so that the animals can't escape during transportation. The cage may have built in handles for easy transportation and the handles should be protected from animals reaching through and harming humans. The trap may be ergonomically and aesthetically designed so not to be intrusive or unsightly. This way it can be placed in communities and neighborhood without offending anyone.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings. Like reference numerals are used to indicate like parts throughout the various drawing figures, wherein:

FIG. 1 is a perspective view of one embodiment of the trap according to this invention;

FIG. 2 is a perspective view of the gate assembly of the trap of FIG. 1 with some components removed for better viewing;

FIG. 3 is a side elevational view of the gate assembly of FIG. 2;

FIG. 4 is a top elevational view of the gate assembly of FIGS. 2-3;

FIG. 5 is an enlarged side elevational view of the gate assembly of FIGS. 2-4 being removed from a retention cage of the trap of FIG. 1;

FIG. 6 is a view similar to FIG. 5 with the gate assembly coupled to the retention cage;

FIG. 7 is an enlarged side elevational view of the access gate assembly coupled to the retention cage according to one embodiment of this;

FIG. 8 is a side elevational view partially in cross-section showing an animal approaching the access gate assembly of the trap;

FIG. 9 is a view similar to FIG. 8 with the animal trapped in the access gate assembly of the trap; and

FIG. 10 is a view similar to FIGS. 8 and 9 with the animal trapped in the trap after having exited the gate assembly and entered the retention cage via an opening,

### DETAILED DESCRIPTION OF THE INVENTION

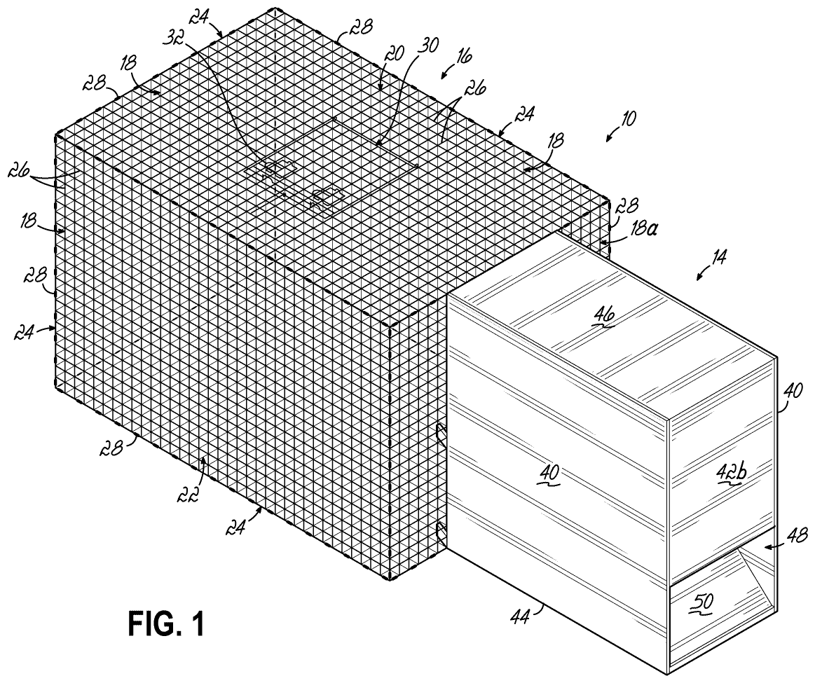

With reference to the drawings, one embodiment of a trap 10 according to this invention is shown in FIG. 1. The trap 10 is described herein for use to trap any type of animal or animals 12. According to the embodiment shown in FIG. 1, the trap 10 includes a gate mechanism 14 and one or more retention chambers 16. Each retention chamber 16 may have four side walls 18, a top wall 20 and a bottom wall 22, but the chamber 16 may be in other configurations according to this invention. Each wall 18, 20 and 22 may be constructed of a wire mesh 24 formed of a number of intersecting wires 26. The walls 18-22 may be of another construction according to this invention.

Each side wall 18 of the retention chamber 16 may be pivotally joined to the top wall 20 by a number of clips 28 which join a perimeter edge of each side wall 18 to one of the perimeter edges of the top wall 20 to form a cruciform arrangement. Each side wall 18 may be pivoted downwardly about the associated clips 28 to be generally perpendicular to the top wall 20 and the adjacent side walls 18 as shown in FIG. 1. The adjacent edges of the adjacent side walls 18 may be joined together by additional clips 28 or by twisting, turning, screwing or threading a multi-turn, convolute elongate wire (not shown in FIG. 1) around the perimeter wires of each of the adjacent side walls 18. The top wall 20 is shown with a top door 30 pivotally mounted to the top wall 20 and secured in a closed position by a clasp 32. In alternative embodiments, the trap 10 may be manufactured in one piece with all of the side walls permanently affixed to each other as well as a bottom wall 22.

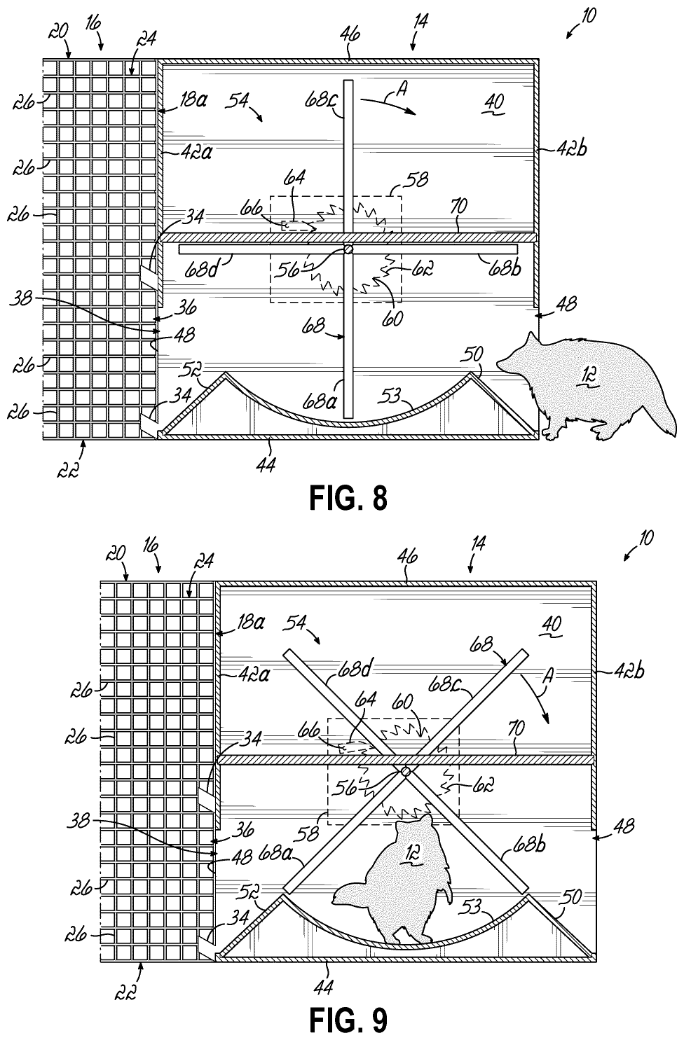

The trap 10 according to various embodiments includes a bottom wall 22 as shown in FIGS. 8-10. The bottom wall 22 is assembled with the side and top walls 18, 20 to form the retention chamber 16. The bottom wall 22 may be mesh or of another configuration.

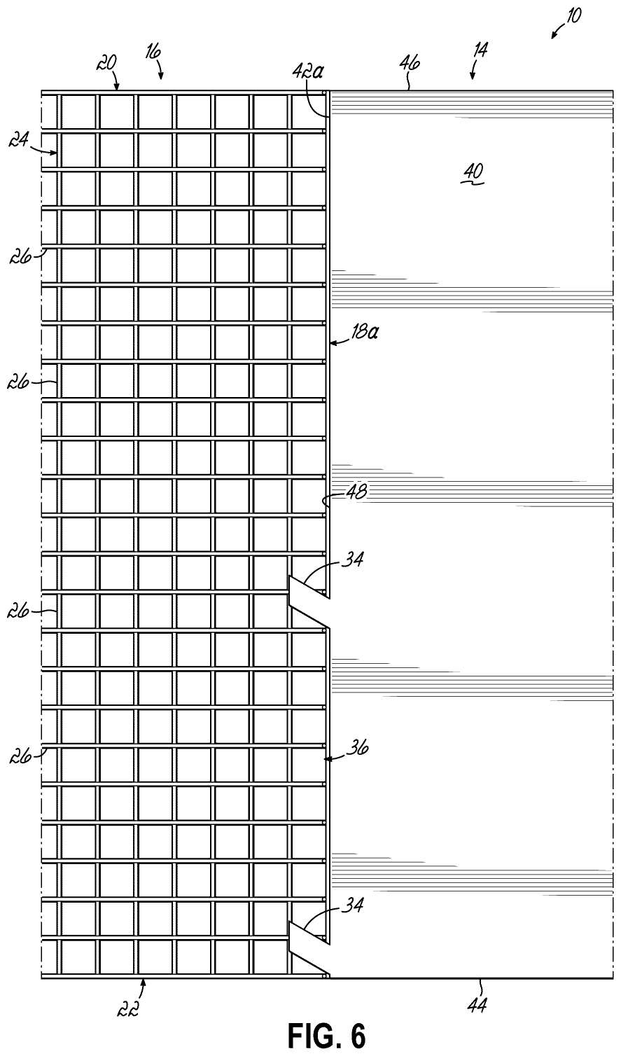

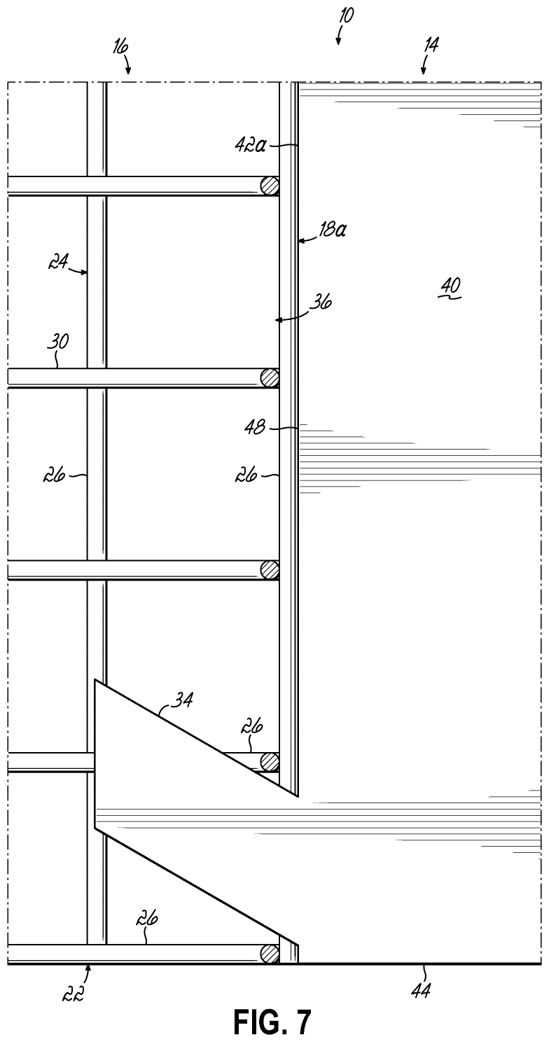

The gate mechanism 14 may be coupled to the retention chamber 16 by a number of retainers 34 which in one embodiment extend from the access door assembly 14 as shown in FIGS. 1, 3, and 5-10. In one embodiment, four retainers 34 extend from the gate assembly 14 to engage side wall 18a of the chamber 16. The gate mechanism 14 may be coupled to the side wall 18a of the chamber 16 to cover an opening 36 in the side wall 18a. The opening 36 is best seen in FIGS. 8-10 and may be located in the side wall 18a adjacent to the bottom wall 22 to be in communication with an exit portal 38 of the access gate assembly 14 to allow for the trapped animal 12 to pass from the gate assembly 14 into the retention chamber 16.

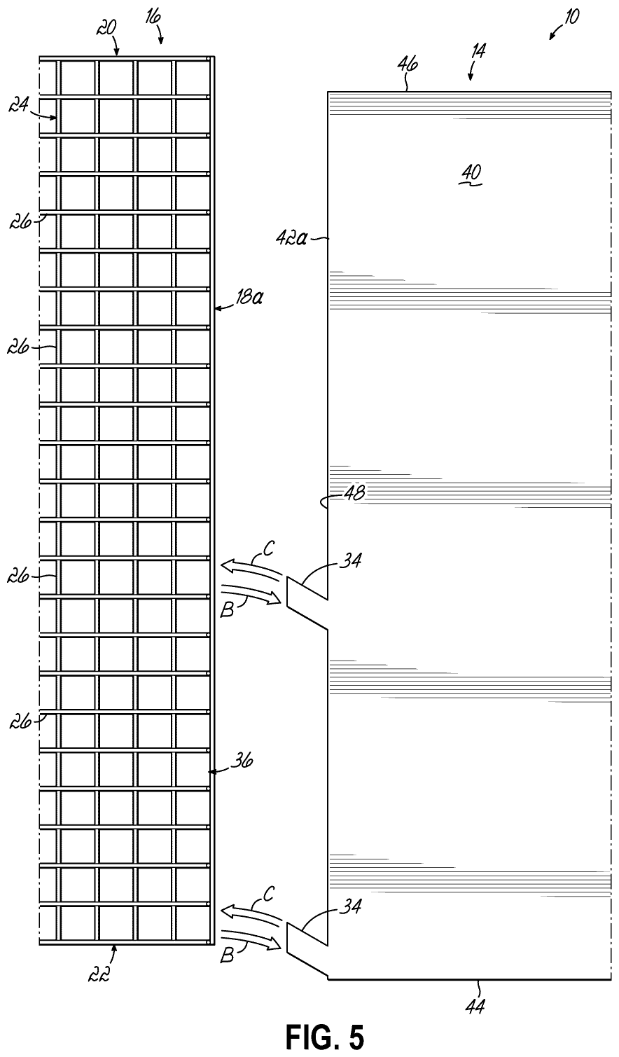

Each retainer 34 may be an upwardly oriented tab extending from the exit end of the gate assembly 14 and which is inserted between adjacent wires 26 in the side wall 18a as shown by arrows B in FIG. 5. The retainer tabs 34 may be oriented upwardly so that the chamber 16 may be moved downwardly toward the retainer tabs 34 when the gate assembly 14 is resting on the ground or other surface as shown in FIG. 5. The upward orientation of the retainer tabs 34 inhibits the chamber 16 from being uncoupled from the gate assembly 14 by simple horizontal relative movement which may be initiated by movement of animals 12 trapped in the chamber 16. The chamber 16 may include a door or closure mechanism (not shown) to cover the opening 36 and prevent the escape of the animals 12 in the chamber 16 when the chamber 16 is uncoupled in the direction of arrows C in FIG. 5 from the gate assembly 14 for replacement of an empty replacement chamber 16a subsequently being coupled to the gate assembly 14 for further trapping.

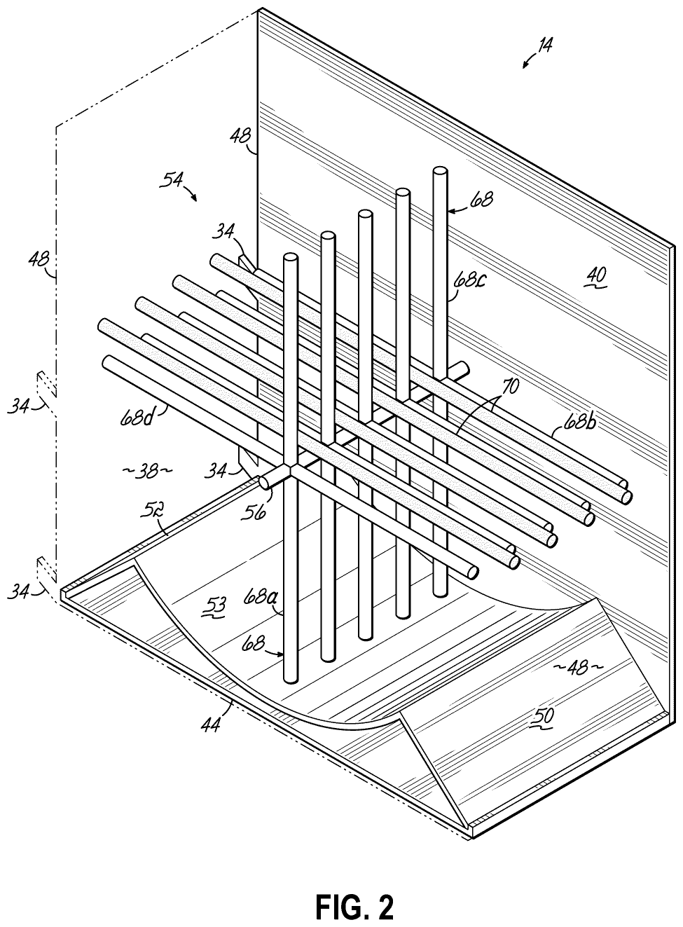

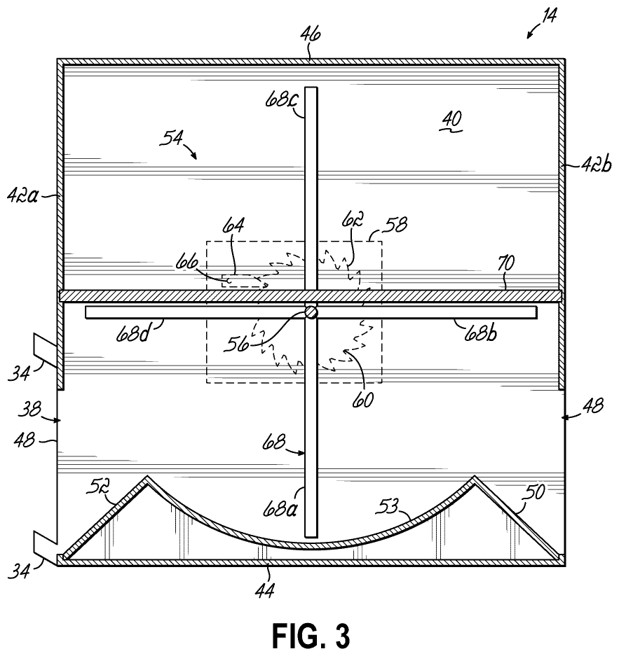

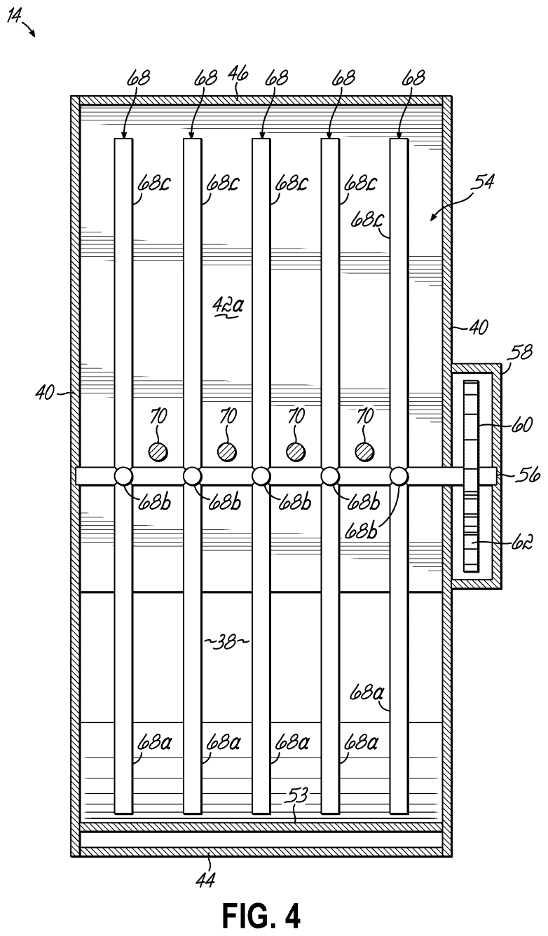

One embodiment of the gate assembly 14 is shown in FIGS. 2-4 and 8-10. The gate assembly 14 may have a generally rectangular box shape formed by a pair of spaced full side walls 40, a pair of spaced half side walls 42a-b, a bottom 44 and an optional top wall 46. The retainer tabs 34 may extend from a free edge 48 of each full side wall 40 adjacent to the exit portal 38 of the gate assembly 14. The exit portal 38 is bound by the bottom 44, a lower edge of one of the half side walls 42a and the free edges of the full side walls 40 from which the retainer tabs 34 project as best seen in FIG. 3. The gate assembly 14 also includes an entry portal 48 opposite from the exit portal 38. The entry portal 48 is bound by the bottom 44, a lower edge of the other one of the half side walls 42b and the free edges of the full side walls 40 opposite from the retainer tabs 34 as best seen in FIG. 3. The bottom 44 of the gate assembly 14 may include an inclined entry ramp 50 adjacent the entry portal 48 and a declined exit ramp 52 adjacent the exit portal 38. The ramps 50, 52 may be joined by an arcuate trough 53 positioned therebetween, see FIGS. 2-3 and 8-10.

As seen most clearly in FIGS. 2-4, the gate assembly 14 includes a gate mechanism 54 to allow for entry of the animal 12 into the trap 10 and prevent its exit from the trap 10 once inside. In one embodiment, the gate mechanism 54 includes a shaft 56 extending generally horizontally across a width of the access door assembly 14 and between the full side walls 40. The shaft 56 is coupled to a gear box 58 mounted on an exterior face of one of the full side walls 40. One end of the shaft 56 extends through the full side wall 40 and into the gear box 58 and is fixed to a ratchet gear 60 housed in the gear box 58. The ratchet gear 60 or a similar mechanical device allows for rotation of the gear 60 and shaft 56 fixed thereto in one direction as indicated by arrow A while preventing it from moving backwards or rotating in the opposite direction. The ratchet gear 60 has a number of teeth 62 extending from its circumference and a pawl 64 which is a spring-loaded finger that pivots and engages the teeth 62. The pawl 64 engages the teeth 62 and slides over them when the gear 60 and shaft 56 rotate in the direction of arrow A, but the shape of the teeth 62 engage with the pawl 64 to inhibit rotation of the gear 60 and shaft in the opposite direction from arrow A. The pawl 64 may be secured to the gear box 58 by a pin 66 for pivotal movement and spring loaded to be biased downwardly to engage the teeth 62 as shown in FIGS. 3 and 8-10.

As seen most clearly in FIG. 2, the shaft 56 has a number of rods 68 projecting outwardly from the shaft 56 in a spaced arrangement. In one embodiment, the rods 68 are arranged in four sets 68a, 68b, 68c and 68d with each set oriented orthogonally or 90° from each of the adjacent sets on the shaft 56. In the embodiment shown in the drawings, each set of rods 68 has five spaced rods 68 extending from the shaft 56. Since the shaft 56 is mounted for rotation in only one direction as shown by arrow A, the rods 68 are likewise limited to one way rotation in the direction of arrow A.

A number of fixed and spaced retention bars 70 extend longitudinally in the access door assembly 14 between the half side walls 42 just above the shaft 56 as shown in FIG. 2. Four such retention bars 70 are shown in the drawings, but this invention is not limited by the number of such bars 70. While each of the rods 68 extending from the shaft 56 are aligned with corresponding rods 68 in the other sets 68a, 68b, 68c and 68d, one of the retention bars 70 is positioned between each pair of adjacent rods 68. The retention bars 70 prevent the animal entering the trap 10 via the gate assembly 14 from escaping upwardly once captured by the gate mechanism 54. Other arrangements for the retention member are within the scope of this invention including, but not limited to, retention bars 70 extending downwardly from the top wall 46 toward the shaft 56 with each retention bar 70 being positioned between each pair of adjacent rods 68.

One mode of operation of the trap 10 according to this invention is shown sequentially in FIGS. 8-10. The animal 12 approaches the entry ramp 50 of the gate assembly 14 as seen in FIG. 8 and may be enticed to climb the entry ramp 50 and enter the path into the retention chamber via the arcuate trough 53 by bait (not shown) within the trap 10. Further forward movement of the animal 12 on the trough 53 pushes one of the sets 68a of rods in the direction of arrow A until the animal is trapped on the trough 53 between an adjacent pair of sets 68a, 68b of rods 68 as shown in FIG. 9. The animal 12 is prevented from escaping the trap 10 back down the entry ramp 50 because of the gate mechanism 54 which does not allow for rotation of the rods 68 and shaft 56 in the direction opposite from arrow A. Likewise, the animal 12 cannot escape upwardly from the trough 53 because it is blocked from upward movement by the retention bars 70. The length and path of the rods 68 during rotation in the direction of arrow A allows for sufficient, but minimal clearance relative to the arcuate trough 53 to prevent the animal 12 from escaping onto the entry ramp 50 from the position shown in FIG. 9. Alternative embodiments of the rods 68 may have a spike or other feature (not shown) projecting into the interior of the trap 10 to deter a trapped animal 12 from exiting the trap 10.

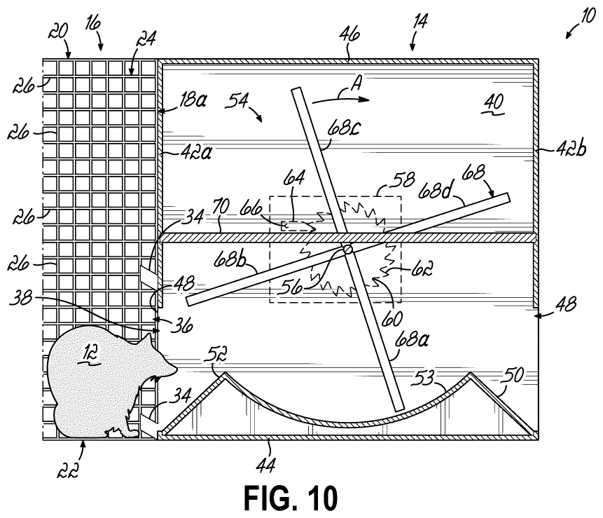

To escape from the trough 53 and continue pursuit of the bait, the animal 12 will push forward against the leading set 68a of rods 68 which can rotate in the direction of arrow A allowing the animal to advance onto the exit ramp 52 as shown in FIG. 10. Once the animal 12 is on the exit ramp 52, it may enter the retention chamber 16 through the opening 36. Here again, the animal 12 is prevented from exiting the access door assembly 14 once on the trough 53 because of the one way rotational feature of the gate mechanism 54; however, subsequent animals 12 may enter the trap 10 by rotating the gate mechanism 54 in the direction of arrow A as previously described relative to FIGS. 8-10.

Once the retention chamber 16 is full of animals 12 or any time prior thereto, the retention chamber 16 may be replaced with a similar such chamber 16 by disengagement from the gate assembly 14 and the retainers 34 releasably coupling them together. The opening 36 may be closed prior to removing the retention chamber 16 with animals 12 therein from the access door assembly 14.

Another aspect of some embodiments is the addition of one or more water bowls and filler bottles in the trap 10. This allows for the possibility that the animals 12 in the retention chamber 16 could be in the trap 10 for up to a week and although they can survive without any issues, providing water is often considered more humane. The bowls can also collect rain and sprinkler water.

While this invention has been described in conjunction with a number of embodiments, those skilled in the art will recognize that certain modifications to the described embodiments still fall within the spirit and scope of the invention. Accordingly, the scope of this invention is not meant to be limited by the disclosure herein, but may be modified while maintaining its novel process and construction, as would be apparent to one of ordinary skill in the art.

1. A trap for a nuisance animal comprising:
a retention chamber for retaining the animal;
a gate mechanism in communication with the retention chamber through which the animal may enter the retention chamber, the gate mechanism being operational in a first direction to allow for ingress of the animal along a path through the gate mechanism and inhibit egress of the animal therefrom once in the gate mechanism.

2. The trap of claim 1 wherein the gate mechanism further comprises:
a rotating assembly having a plurality of spaced gate members wherein the animal is positioned between a pair of adjacent gate members when in the gate mechanism.

3. The trap of claim 2 wherein each gate member further comprises a plurality of spaced rods.

4. The trap of claim 2 wherein the gate mechanism further comprises a shaft mounted for rotation in the first direction, the plurality of spaced gate members being mounted to the shaft for rotation in the first direction.

5. The trap of claim 2 further comprising:
a retention member juxtaposed to the rotating assembly to inhibit the animal from escaping from the trap when in the gate mechanism.

6. The trap of claim 5 wherein the retention member further comprises a plurality of spaced retention bars extending generally parallel to the path.

7. The trap of claim 3 further comprising:
a plurality of spaced retention bars extending generally parallel to the path and juxtaposed to the rotating assembly to inhibit the animal from escaping from the trap when in the gate mechanism, each of the plurality of spaced retention bars being interleaved between a pair of adjacent ones of the plurality of spaced rods.

8. The trap of claim 5 wherein the retention member further comprises a plurality of spaced retention bars extending generally parallel to the path.

9. The trap of claim 1 further comprising:
an inclined entrance ramp proximate an entrance to the gate mechanism to lead the animal into the gate mechanism; and
a declined exit ramp proximate an exit from the gate mechanism to lead the animal into the retention chamber.

10. The trap of claim 2 further comprising:
an arcuate trough juxtaposed to the rotating assembly to support the animal when in the gate mechanism.

11. The trap of claim 1 further comprising:
a ratchet; and
a pawl engageable with the ratchet to provide for the gate mechanism operation in the first direction and inhibit operation of the gate mechanism in a second, opposite direction.

12. The trap of claim 1 wherein the gate mechanism is selective attachable to and detachable from the retention chamber such that the gate mechanism may be attached to a second retention chamber when the animal is to be removed from the retention chamber.

13. A trap for a nuisance animal comprising:
a retention chamber for retaining the animal;
a gate mechanism in communication with the retention chamber through which the animal may enter the retention chamber, the gate mechanism being operational in a first direction to allow for ingress of the animal along a path through the gate mechanism and inhibit egress of the animal therefrom once in the gate mechanism;
a rotating assembly having a plurality of sets of spaced rods wherein the animal is positioned between a pair of adjacent sets spaced rods when in the gate mechanism;
a shaft mounted for rotation in the first direction, the plurality of sets of spaced rods being mounted to the shaft for rotation in the first direction; and
a plurality of spaced retention bars extending generally parallel to the path and juxtaposed to the rotating assembly to inhibit the animal from escaping from the trap when in the gate mechanism.

14. The trap of claim 13 further comprising:
an inclined entrance ramp proximate an entrance to the gate mechanism to lead the animal into the gate mechanism; and
a declined exit ramp proximate an exit from the gate mechanism to lead the animal into the retention chamber.

15. The trap of claim 14 further comprising:
an arcuate trough juxtaposed to the rotating assembly intermediate to the inclined entrance ramp and the declined exit ramp to support the animal when in the gate mechanism.

16. The trap of claim 13 further comprising:
a ratchet; and
a pawl engageable with the ratchet to provide for the gate mechanism operation in the first direction and inhibit operation of the gate mechanism in a second, opposite direction.

17. The trap of claim 13 wherein each of the plurality of spaced retention bars is interleaved between a pair of adjacent ones of the plurality of spaced rods.

18. A trap for a nuisance animal comprising:
a retention chamber for retaining the animal;
a gate mechanism in communication with the retention chamber through which the animal may enter the retention chamber, the gate mechanism being operational in a first direction to allow for ingress of the animal along a path through the gate mechanism and inhibit egress of the animal therefrom once in the gate mechanism;
a rotating assembly having a plurality of sets of spaced rods wherein the animal is positioned between a pair of adjacent sets spaced rods when in the gate mechanism;
a shaft mounted for rotation in the first direction, the plurality of sets of spaced rods being mounted to the shaft for rotation in the first direction;
a plurality of spaced retention bars extending generally parallel to the path and juxtaposed to the rotating assembly to inhibit the animal from escaping from the trap when in the gate mechanism, wherein each of the plurality of spaced retention bars is interleaved between a pair of adjacent ones of the plurality of spaced rods;
a ratchet; and
a pawl engageable with the ratchet to provide for the gate mechanism operation in the first direction and inhibit operation of the gate mechanism in a second, opposite direction.

19. The trap of claim 18 further comprising:
an inclined entrance ramp proximate an entrance to the gate mechanism to lead the animal into the gate mechanism; and
a declined exit ramp proximate an exit from the gate mechanism to lead the animal into the retention chamber.

20. The trap of claim 19 further comprising:
an arcuate trough juxtaposed to the rotating assembly intermediate to the inclined entrance ramp and the declined exit ramp to support the animal when in the gate mechanism.
